(19) United States
(12) Patent Application Publication
(10) Pub. No.: US 2026/0121545 A1
(43) Pub. Date: Apr. 30, 2026

(54) MULTI-PHASE CONVERTING CIRCUIT AND MULTI-PHASE CONVERTER

(71) Applicant: LITE-ON TECHNOLOGY CORPORATION, Taipei (TW)

(72) Inventors: Bo-Ruei CIOU, Taipei (TW); Chen CHEN, Taipei (TW)

(21) Appl. No.: 19/073,081

(22) Filed: Mar. 7, 2025

Related U.S. Application Data
(60) Provisional application No. 63/711,797, filed on Oct. 25, 2024.

(30) Foreign Application Priority Data
Jan. 22, 2025 (CN) 202520148015.6

(51) Int. Cl. H02M 3/335; H02M 3/00

(52) U.S. Cl. CPC H02M 3/33576; H02M 3/01

(57) ABSTRACT

An aspect of the present disclosure features a multi-phase converting circuit, including a primary side switch circuit. The primary side switch circuit includes multiple transistor complementary pairs. The multiple transistor complementary pairs are parallel-connected. The multi-phase converting circuit also includes resonant tank coupled to the primary side switch circuit and including multiple capacitors, multiple resonant inductors and multiple transformers. The multi-phase converting circuit also includes a secondary side switch circuit. The secondary side switch circuit is formed by a full bridge structure. Each transistor complementary pair includes a first transistor and a second transistor. The first transistor and the second transistor are serial-connected. Each transistor complementary pair includes a node between the first transistor and the second transistor. The node is coupled to respective one of the resonant inductors.

This application claims the benefit of U.S. provisional application Ser. No. 63/711,797, filed Oct. 25, 2024, the subject matter of which is incorporated herein by reference, and claims the benefit of People's Republic of China application Serial No. 202520148015.6, filed on Jan. 22, 2025, the subject matter of which is incorporated herein by reference.

### TECHNICAL FIELD

The disclosure relates in general to techniques of multi-phase converting circuit and multi-phase converter, and more particularly, to techniques of multi-phase converting circuit and multi-phase converter constructed by a Δ-Lr&Cr-Y-Full Bridge structure.

### BACKGROUND

Currently, Full Bridge-Full Bridge structure is mainly applied to multi-phase converting circuits or multi-phase converters. However, component errors (such as resonant inductor or resonant capacitor, or both) of multi-phase converting circuits or multi-phase converters with Full Bridge-Full Bridge structure may cause greater error of currents of such type of multi-phase converting circuits or multi-phase converters. Additionally, magnetic core loss and copper loss of such type of multi-phase converting circuits or multi-phase converters are needed to be improved. Thus, there are needs for techniques of multi-phase converting circuit or multi-phase converter for improving magnetic core loss and copper loss and reducing current error caused by the component error.

### SUMMARY

The present disclosure provides techniques of multi-phase converting circuit and multi-phase converter of a Triangle-Inductor-Capacitor-Y-shape (Δ-Lr&Cr-Y)-Full Bridge structure, which is with less core loss and total loss, and with higher tolerance for current errors caused by component errors.

The first aspect of the present disclosure features a multi-phase converting circuit. The multi-phase converting circuit comprises a primary side switch circuit including multiple transistor complementary pairs. The multiple transistor complementary pairs are parallel-connected. The multi-phase converting circuit also comprises a resonant tank coupled to the primary side switch circuit and including multiple capacitors, multiple resonant inductors and multiple transformers. The multi-phase converting circuit also comprises a secondary side switch circuit constructed by a full bridge structure. Each transistor complementary pair includes a first transistor and a second transistor, and the first transistor and the second transistor are serial-connected. Each transistor complementary pair includes a node between the first transistor and the second transistor, and the node is coupled to respective one of the plurality of resonant inductors.

The second aspect of the present disclosure features a multi-phase converter. The multi-phase converter comprises multiple resonant inductor structures. Each resonant inductor structure includes an inductor upper cover, an inductor lower cover, an inductor core column and a winding coil. The inductor core column is disposed between the inductor upper cover and the inductor lower cover, and includes an air gap. The winding coil is arranged around the inductor core column. The multi-phase converter also comprises multiple transformer structures. Each transformer structure includes a transformer upper cover, a transformer lower cover, a transformer core column, a primary side winding coil and a secondary side winding coil. The transformer core column is disposed between the transformer upper cover and the transformer lower cover, and includes an air gap. The primary side winding coil and the secondary winding coil are arranged around the transformer core column. The multi-phase converter also comprises a primary side switch circuit including multiple transistor complementary pairs. The multiple transistor complementary pairs are parallel-connected. The multi-phase converter also comprises a secondary side switch circuit coupled to each secondary side winding coil of the multiple transformer structures and constructed by a full bridge structure. Each transistor complementary pair includes a first transistor and a second transistor, and the first transistor and the second transistor are serial-connected. Each transistor complementary pair includes a node between the first transistor and the second transistor, and the node is coupled to the winding coil of respective one of the multiple resonant inductor structures. The primary side winding coil of one of the multiple transformer structures is coupled to the winding coil of one of the multiple resonant inductor structures.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is illustrating a circuit diagram of a multi-phase converting circuit, according to some implementations of the present disclosure.

FIG. 2 is illustrating a time diagram of multiple signals of the multi-phase converting circuit, according to some implementations of the present disclosure.

FIG. 3A is illustrating a comparison diagram of resonant inductor error of a multi-phase converter of Triangle-Inductor-Capacitor-Y-shape-Full Bridge structure and a multi-phase converter of Full Bridge-Full Bridge structure, according to some implementations of the present disclosure.

FIG. 3B is illustrating a comparison diagram of resonant capacitor error of the multi-phase converter of Triangle-Inductor-Capacitor-Y-shape-Full Bridge structure and the multi-phase converter of Full Bridge-Full Bridge structure, according to some implementations of the present disclosure.

FIG. 3C is illustrating a comparison diagram of resonant inductor error and resonant capacitor error of the multi-phase converter of Triangle-Inductor-Capacitor-Y-shape-Full Bridge structure and the multi-phase converter of Full Bridge-Full Bridge structure, according to some implementations of the present disclosure.

FIG. 4 is illustrating a comparison diagram of copper loss of the multi-phase converter of Triangle-Inductor-Capacitor-Y-shape-Full Bridge structure and the multi-phase converter of Full Bridge-Full Bridge structure, according to some implementations of the present disclosure.

FIG. 5 is illustrating a side view of a primary side resonant inductor structure and a transformer structure of a multi-phase converter, according to some implementations of the present disclosure.

FIG. 6 is illustrating a pictorial view of the primary side resonant inductor structure and the transformer structure of the multi-phase converter, according to some implementations of the present disclosure.

FIG. 7 is illustrating a pictorial view and a side view of an integrated inductor and transformer structure of a multi-phase converter, according to some implementations of the present disclosure.

FIG. 8 is illustrating a side view of the integrated inductor and transformer structure and an arrangement diagram of the transformer winding coil of the multi-phase converter, according to some implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

The terms “comprise,” “comprising,” “include,” “including,” “has,” “having,” etc. used in this specification are open-ended and mean “comprises but not limited.” The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative embodiments but, like the illustrative embodiments, should not be used to limit the present disclosure. The elements included in the illustrations herein may not be drawn to scale.

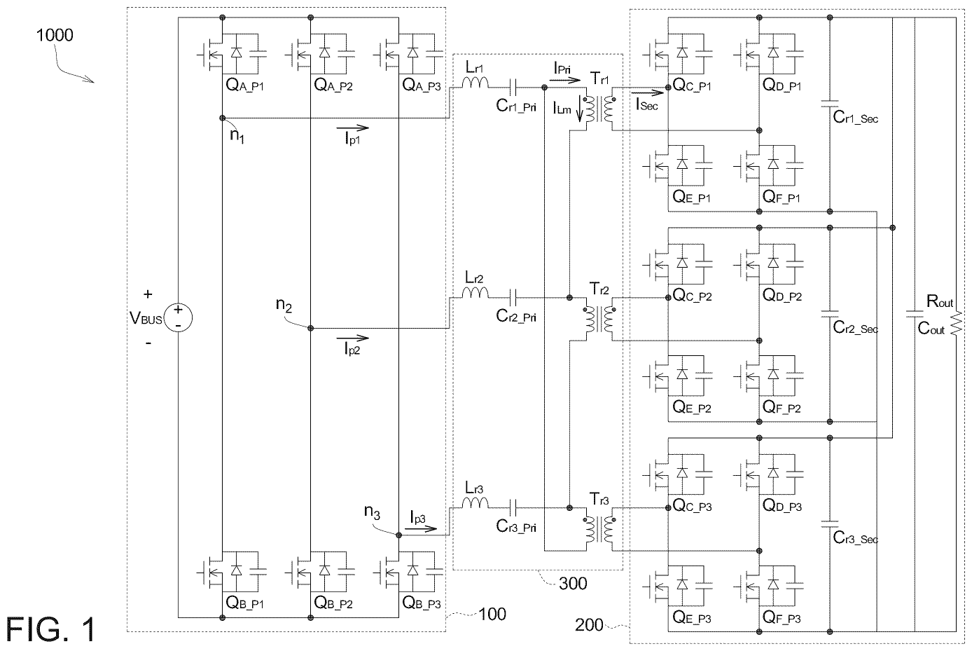

FIG. 1 is illustrating a circuit diagram of a multi-phase converting circuit 1000, according to some implementations of the present disclosure. In FIG. 1, the multi-phase converting circuit 1000 is implemented as, but not limited to, a three phases converting circuit as an example. The multi-phase converting circuit 1000 includes a primary side switching circuit 100, a resonant tank 300 and a secondary side switching circuit 200. The resonant tank 300 is coupled to the primary side switching circuit 100 and the secondary side switching circuit 200.

The primary side switching circuit 100 includes multiple transistors (first transistors Q_{A_P1} to Q_{A_P3} and second transistors Q_{B_P1} to Q_{B_P3}) as switches. The first transistor Q_{A_P1} and the second transistor Q_{B_P1} are serial-connected to form a transistor complementary pair. Similarly, the first transistor Q_{A_P2} and the second transistor Q_{B_P2}, and the first transistor Q_{A_P3} and the second transistor Q_{B_P3} are respectively serial-connected to form another two transistor complementary pairs. As shown in FIG. 1, these transistor complementary pairs are parallel-connected (the first transistor Q_{A_P1} and the second transistor Q_{B_P1}, the first transistor Q_{A_P2} and the second transistor Q_{B_P2}, and the first transistor Q_{A_P3} and the second transistor Q_{B_P3} are parallel-connected).

The resonant tank 300 includes multiple primary side resonant capacitors (primary side resonant capacitors C_{r1_Pri} to C_{r3_Pri}), multiple primary side resonant inductors (primary side resonant inductors Lᵣ₁ to Lᵣ₃) and multiple transformers (transformers Tᵣ₁ to Tᵣ₃). Each of the primary side resonant inductors (primary side resonant inductors Lᵣ₁ to Lᵣ₃) are respectively serial-connected to each transformers (transformers Tᵣ₁ to Tᵣ₃).

The secondary side switching circuit 200 includes multiple transistors (transistors Q_{C_P1} to Q_{F_P3}) as switches, multiple secondary side resonant capacitors (secondary side resonant capacitors C_{r1_Sec} to C_{r3_Sec}), an output capacitor Cₒᵤₜ and an output resistance Rₒᵤₜ. The secondary side switching circuit 200 is constructed by a full bridge structure, as shown in FIG. 1.

A node (the node n₁ to the node n₃) is between each first transistors and each second transistors forming a transistor complementary pair of the primary side switching circuit 100. For example, the node n₁ is between the first transistor Q_{A_P1} and the second transistor Q_{B_P1} forming the transistor complementary pair. Each node (the node n₁ to the node n₃) coupled to respective one of multiple resonant inductors of the resonant tank 300, such as the node n₁ is coupled to the resonant inductor Lᵣ₁.

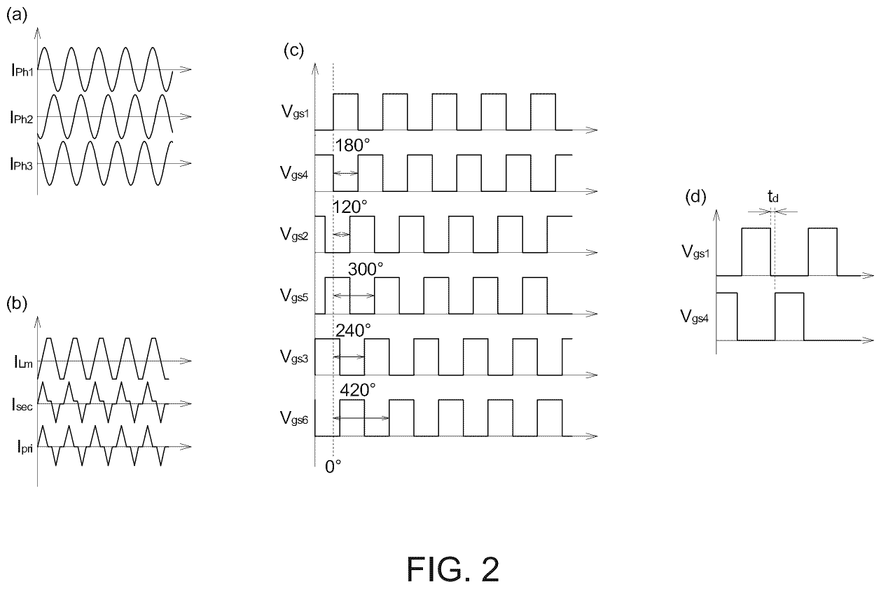

FIG. 2 is illustrating a time diagram of multiple signals of the multi-phase converting circuit 1000, according to some implementations of the present disclosure. Referring to FIGS. 1 and 2, when the primary side switching circuit 100 is coupled to an input voltage VBUS, a 120 degrees phase difference may be applied between inductor currents with different phases (a first phase current I_{P1}, a second phase current I_{P2} and a third phase current I_{P3}) of nodes with different phases (the node n₁ is corresponding to an first phase, the node n₂ is corresponding to a second phase, and the node n₃ is corresponding to a third phase), such that a primary side inductor current I_{Lm}, a primary side current I_{Pri} and a secondary side current I_{Sec} of the multi-phase converting circuit 1000 include the waveform as shown by schema (a) of FIG. 2. To achieve such effect, a controller can be coupled to a control terminal of each first transistor (such as the gate terminal of each first transistor) and a control terminal of each second transistor (such as the gate terminal of each second transistor) for controlling each transistor as switches. As the example in FIG. 2, the controller respectively provides gate voltages V_{gs1} to V_{gs3} to first transistors Q_{A_P1} to Q_{A_P3}, and provides gate voltages V_{gs4} to V_{gs6} to first transistors Q_{B_P1} to Q_{B_P3}, such that the 120 degrees phase difference is between each first transistor (between first transistors Q_{A_P1} to Q_{A_P3}) and between each second transistor (between second transistors Q_{B_P1} to Q_{B_P3}), and a 180 degrees phase difference is between each first transistor and each second transistor (such as between the first transistor Q_{A_P1} and the second transistor Q_{B_P1}), as shown by schema (c) of FIG. 2. To prevent the first transistor and the second transistor of the transistor complementary pair from being turned on simultaneously, according to a parasite capacitance of the primary side switch circuit 100 and the secondary side switch circuit 200, and a magnetizing inductor of the plurality of transformers, the controller sets a dead zone time td between switching timings of the first transistor and the second transistor, as shown by schema (d) of FIG. 2. When the magnetizing inductor is less or smaller, the source-drain voltage of switches in the primary side switching circuit 100 can be discharged to 0V in a short time, such that the dead zone time td may be set less or shorter. When the magnetizing inductor is greater, the source-drain voltage of switches in the primary side switching circuit 100 needs more time to be discharged to 0V, such that the dead zone time td may be set longer to enable the zero voltage switch (ZVS) function.

The table I below represents the design data of electric specifications of the multi-phase converter of Full Bridge-Full Bridge structure and the multi-phase converter of Δ-Lr&Cr-Y-Full Bridge structure under same current condition of ZVS, and table II below represents magnetic core (or core) specifications of the multi-phase converter of Full Bridge-Full Bridge structure and the multi-phase converter of Δ-Lr&Cr-Y-Full Bridge structure.

TABLE I

| | | |
|---|---|---|
| Electric | Full Bridge- | Δ-Lr&Cr—Y- |
| specifications | Full Bridge | Full Bridge |

| | | | | |
|---|---|---|---|---|
| Input voltage | 400 | V | 400 | V |
| Output voltage | 49.58 | V | 49.46 | V |
| Output watts | 10 | kW | 10 | kW |
| Switching | 100 | kHz | 100 | kHz |
| frequency | | | | |

| | | |
|---|---|---|
| Operating point | At | At |
| (full load) | resonance | resonance |
| | point | point |

| | | | | |
|---|---|---|---|---|
| Cₒₛₛ of primary | 105 | pF | 105 | pF |
| side switches | | | | |
| (parasitic | | | | |
| capacitance) | | | | |
| Dead zone time | 50 | ns | 50 | ns |

| | | |
|---|---|---|
| Winding ration | 16:2 | 16:2 |

| | | | | |
|---|---|---|---|---|
| Magnetizing | 157.34 | μH | 420.97 | μH |
| inductor (Lₘ) | | | | |
| Resonant | 1.37 | μF | 1.79 | μF |
| capacitor (Cᵣ) | | | | |
| Resonant | 1.2 | μH | 1.2 | μH |
| capacitor | | | | |
| inductor (Lᵣ) | | | | |
| Leakage | 0.65 | H | 0.65 | H |
| inductance | | | | |
| (Lₗₖ) | | | | |

TABLE II

| | | |
|---|---|---|
| Magnetic core | Full Bridge- | Δ-Lr&Cr—Y- |
| specification | Full Bridge | Full Bridge |

| | | | | |
|---|---|---|---|---|
| Ae | 174.04 | mm2 | 174.04 | mm2 |

| | | |
|---|---|---|
| Material | KF9 | KF9 |

| | | | | |
|---|---|---|---|---|
| Maximum | 0.25 | T | 0.25 | T |
| magnetic flux | | | | |
| density Bₘₐₓ | | | | |
| (assumption) | | | | |
| Primary side | 0.1*500 | plies | 0.1*500 | plies |
| winding coil | | | | |

| | | |
|---|---|---|
| Secondary | Copper sheet | Copper sheet |
| side winding | 0.6 mm | 0.6 mm |

coil

| | | |
|---|---|---|
| Winding ratio | 16:2 | 16:2 |

| | | | | |
|---|---|---|---|---|
| Air gap | 0.38 | mm | 0.12 | mm |

Based on the data of the table I and table II, the table III below represents performance comparison of a three phases converter of Full Bridge-Full Bridge structure and a three phases converter while converting from 500V to 50 V at 10 kW. According to the table 3, it can be known that the effective value of primary side switch current (A) and the effective value of secondary side transformer current (A) of Δ-Lr&Cr-Y-Full Bridge structure is obviously higher than those of the Full Bridge-Full Bridge structure. Therefore, since the air gap of Full Bridge-Full Bridge structure is larger, the copper wire loss is affected, such that the copper wire loss of Full Bridge-Full Bridge structure is higher than that of the Δ-Lr&Cr-Y-Full Bridge structure.

TABLE III
Three Phase LLC (500 V to 50 V @10 kW)

| | Full Bridge- | Δ-Lr&Cr—Y- |
|---|---|---|
| LLC structure | Full Bridge | Full Bridge |
| Peak value of | 14.13 | 26.76 |
| primary side switch | | |
| current (A) | | |
| Effective value of | 7.13 | 13.03 |
| primary side switch | | |
| current (A) | | |
| Effective value of | 10.09 | 11.22 |
| primary side | | |
| transformer current | | |
| (A) | | |
| Number of primary | 12 | 6 |
| side switches | | |
| Peak value of | 105.71 | 167.98 |
| secondary side | | |
| switch current (A) | | |
| Effective value of | 52.54 | 62.33 |
| secondary side | | |
| switch current (A) | | |
| Effective value of | 74.2 | 88 |
| secondary side | | |
| transformer current | | |
| (A) | | |
| Number of | 12 | 12 |
| secondary side | | |
| switches | | |
| Effective value of | 10.09 | 18.42 |
| resonant inductor | | |
| current (A) | | |

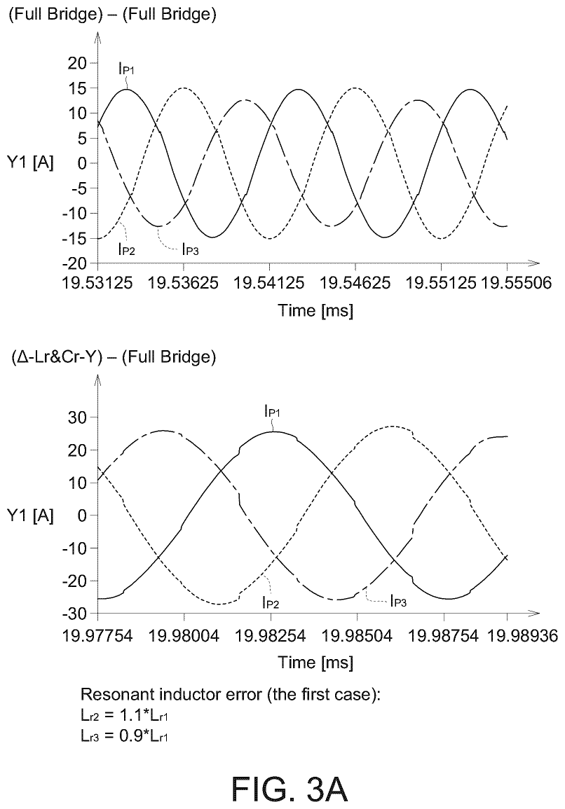

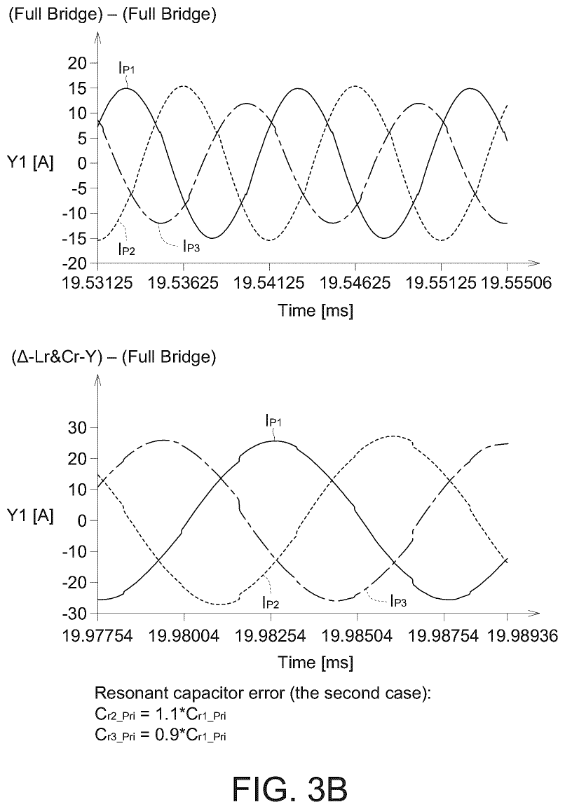

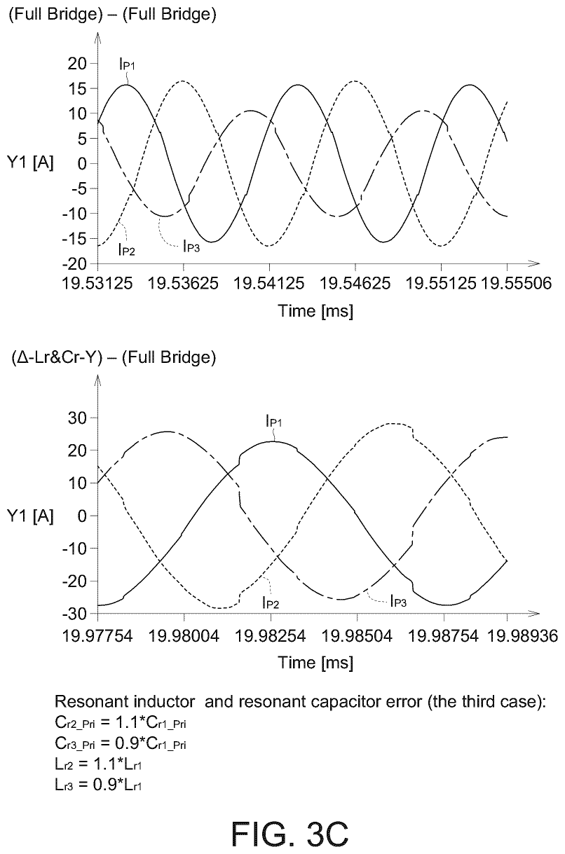

FIG. 3A is illustrating a comparison diagram of resonant inductor error of a multi-phase converter of Triangle-Inductor-Capacitor-Y-shape(Δ-Lr&Cr-Y)-Full Bridge structure and a multi-phase converter of Full Bridge-Full Bridge structure, according to some implementations of the present disclosure, FIG. 3B is illustrating a comparison diagram of resonant capacitor error of the multi-phase converter of Δ-Lr&Cr-Y-Full Bridge structure and the multi-phase converter of Full Bridge-Full Bridge structure, according to some implementations of the present disclosure, and FIG. 3C is illustrating a comparison diagram of resonant inductor error and resonant capacitor error of the multi-phase converter of Δ-Lr&Cr-Y-Full Bridge structure and the multi-phase converter of Full Bridge-Full Bridge structure, according to some implementations of the present disclosure. In the first case of the FIG. 3A, it takes the error of resonant capacitors (the primary side resonant capacitors C_{r1_Pri} to C_{r3_Pri}) as ±10% as an example (Lᵣ₁=1.1*Lᵣ₁ and Lᵣ₃=0.9*Lᵣ₁). In the second case of the FIG. 3B, it takes the error of resonant inductors (resonant inductors Lᵣ₁ to Lᵣ₃) as ±10% as an example (C_{r2_Pri}=1.1*C_{r1_Pri} and C_{r3_Pri}=0.9*C_{r1_Pri}). In the third case of the FIG. 3C, it takes both the error of resonant capacitors (the primary side resonant capacitors C_{r1_Pri} to C_{r3_Pri}) as ±10% and the error of resonant inductors (resonant inductors Lᵣ₁ to Lᵣ₃) as ±10%, as an example (Lᵣ₁=1.1*Lᵣ₁, Lᵣ₃=0.9*Lᵣ₁, C_{r2_Pri}=1.1*C_{r1_Pri} and C_{r3_Pri}=0.9*C_{r1_Pri}). According to data in table I and table II, and error comparison of table IV below, it can be know that, in the first case, the second case and the second case, comparing to Full Bridge-Full Bridge structure, the current difference caused by component errors (resonant inductor error, resonant capacitor error, or both) of the Δ-Lr&Cr-Y-Full Bridge structure of implementations according to the present disclosure is smaller.

TABLE IV

| | | Full Bridge- | | Δ-Lr&Cr—Y- | |
|---|---|---|---|---|---|
| | | Full Bridge | | Full Bridge | |
| No | First phase | 14.12 A | | 26.2 A | |
| error | current I_{P1} | | | | |
| (base) | Second | 14.12 A | | 26.2 A | |
| | phase | | | | |
| | current I_{P2} | | | | |
| | Third phase | 14.12 A | | 26.2 A | |
| | current I_{P3} | | | | |
| First | First phase | 14.74 | (+4.39%) | 25.6 | (−2.29%) |
| case | current I_{P1} | | | | |
| | Second | 12.61 | (−10.69%) | 25.89 | (−1.18%) |
| | phase | | | | |
| | current I_{P2} | | | | |
| | Third phase | 15.03 | (+6.45%) | 27.21 | (+3.85%) |
| | current I_{P3} | | | | |
| Second | First phase | 15.01 | (+6.3%) | 25.62 | (−2.21%) |
| case | current I_{P1} | | | | |
| | Second | 11.98 | (−15.15%) | 25.93 | (−1.03%) |
| | phase | | | | |
| | current I_{P2} | | | | |
| | Third phase | 15.45 | (+9.41%) | 27.18 | (+3.74%) |
| | current I_{P3} | | | | |
| Third | First phase | 15.72 | (+11.33%) | 25.08 | (−4.27%) |
| case | current I_{P1} | | | | |
| | Second | 10.54 | (−25.35%) | 25.65 | (−2.1%) |
| | phase | | | | |
| | current I_{P2} | | | | |
| | Third phase | 16.46 | (+16.57%) | 28.18 | (+7.57%) |
| | current I_{P3} | | | | |

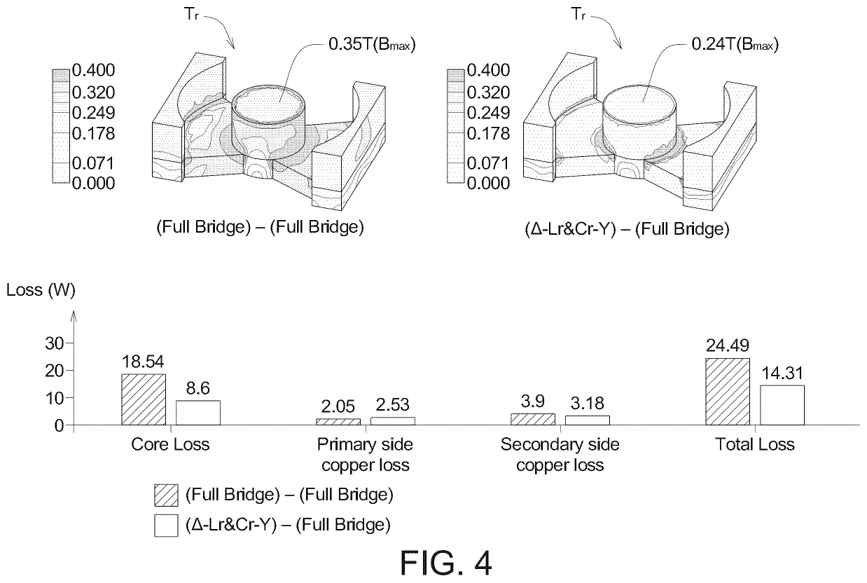

FIG. 4 is illustrating a comparison diagram of core loss and copper loss of the transformer Tᵣ of the multi-phase converter of Δ-Lr&Cr-Y-Full Bridge structure and the multi-phase converter of Full Bridge-Full Bridge structure, according to some implementations of the present disclosure. As shown in FIG. 4, at transformer Tᵣ of Δ-Lr&Cr-Y-Full Bridge structure, since Bmax is smaller, the core loss is significantly smaller under the same magnetic core, and thus, comparing to the total loss of the transformer Tᵣ of Full Bridge-Full Bridge structure, the total loss of transformer Tᵣ of Δ-Lr&Cr-Y-Full Bridge structure can be reduced about 41.56%.

According to comparisons above, it can be know that, comparing to conventional Full Bridge-Full Bridge structure, the Δ-Lr&Cr-Y-Full Bridge structure provided by implementations of present disclosure is with less core loss and total loss, and with higher tolerance for current errors caused by component errors.

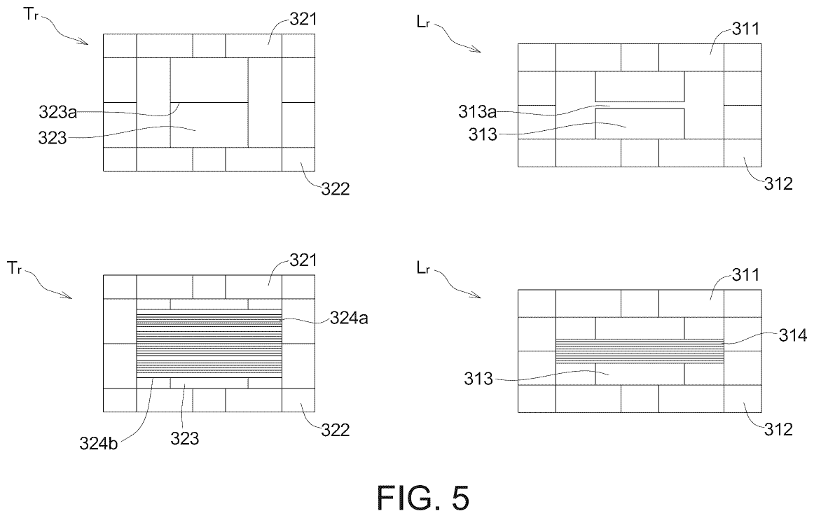

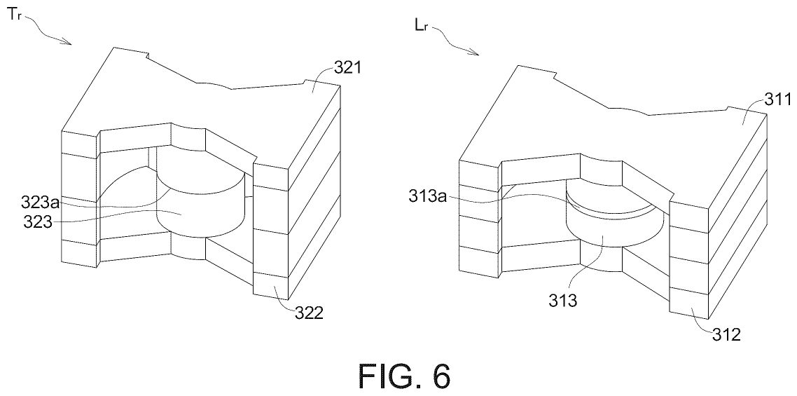

FIGS. 5 and 6 are respectively illustrating a side view and a pictorial view of a primary side resonant inductor (Lᵣ) structure and a transformer (Tᵣ) structure of a multi-phase converter, according to some implementations of the present disclosure As shown in FIGS. 5 and 6, the primary side resonant inductor Lᵣ (such as primary side resonant inductors Lᵣ₁ to Lᵣ₃) may include an inductor upper cover 311, an inductor lower cover 312, an inductor core column 313 and the winding coil 314. The inductor core column 313 is disposed between the inductor upper cover 311 and the inductor lower cover 312, and the inductor core column 313 includes an air gap 313a. The winding coil 314 is arranged around the inductor core column 313. The transformer (Tᵣ) structure (Such as transformers Tᵣ₁ to Tᵣ₃ in FIG. 1) may include a transformer upper cover 321, a transformer lower cover 322, a transformer core column 323, a primary side winding coil 324a and the secondary side winding coil 324b. The transformer core column 323 is disposed between the transformer upper cover 321 and the transformer lower cover 322, and the transformer core column 323 includes an air gap 323a. The primary side winding coil 324a and the secondary side winding coil 324b are disposed around the transformer core column 323. The secondary side winding coil 324b may be coupled to a secondary side switching circuit (such as the secondary side switching circuit 200 of FIG. 1) of a multi-phase converter, and the primary side winding coil 324a may be coupled to the winding coil 314 of the primary side resonant inductor Lᵣ. In some implementations, the primary side winding coil 324a and the secondary side winding coil 324 disposed on the transformer core column 323 are wound clockwise, and the winding coil 314 disposed on the inductor core column 313 is wound clockwise. In some implementations, the primary side winding coil 324a and the secondary side winding coil 324b disposed on the transformer core column 323 are wound counterclockwise, and the winding coil 314 disposed on the inductor core column 313 is wound counterclockwise.

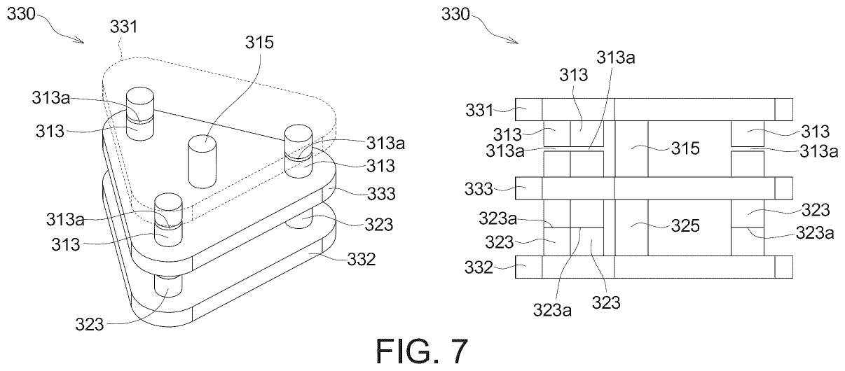

FIG. 7 is illustrating a pictorial view and a side view of an integrated inductor and transformer structure 330 of a multi-phase converter, according to some implementations of the present disclosure. The multi-phase converter in FIG. 7 is described using a three phases converter as an example, and thus an integrated inductor and transformer structure 330 in FIG. 7 includes three primary side resonant inductors Lᵣ and three transformers Tᵣ. As shown in FIG. 7, the integrated inductor and transformer structure 330 includes an integrated upper cover 331, which may be referred to a combination of three inductor upper covers 311 of three primary side resonant inductors (Lᵣ) structure in FIG. 6. The integrated inductor and transformer structure 330 includes an integrated middle layer 333, which may be referred to a combination of multiple inductor lower covers 312 of three primary side resonant inductors (Lᵣ) structure, and multiple transformer upper covers 321 of three transformer (Tᵣ) structure, in FIG. 6. The integrated inductor and transformer structure 330 includes an integrated lower cover 332, which may be referred to a combination of three transformer lower covers 322 of three transformer (Tᵣ) structure in FIG. 6. At the upper level of the integrated inductor structure (between the integrated upper cover 331 and the integrated middle layer 333), excepting disposing three inductor core columns 313 and air gaps 313a corresponding to three inductors, and inductor central core column 315 is disposed between the integrated upper cover 331 and the integrated middle layer 333, and on the geometric center thereof. The inductor central core column 315 is without air gap, and the inductor central core column 315 and each inductor core column 313 are equidistant from each other, as shown in FIG. 7. In some implementations, cross-sectional areas of the inductor central core column 315 and each inductor core column 313 are consistent in size, and each air gap 313a of each inductor core column 313 is identical. Similarly, at the lower level of the integrated transformer structure (between the integrated middle layer 333 and the integrated lower cover 332), excepting disposing three transformer core columns 323 and air gaps 323a corresponding to three transformers, and transformer central core column 325 is disposed between the integrated middle layer 333 and the integrated lower cover 332, and on the geometric center thereof. The transformer central core column 325 is without air gap, and the transformer central core column 325 and each transformer core column 323 are equidistant from each other, as shown in FIG. 7. In some implementations, cross-sectional areas of the transformer central core column 325 and each transformer core column 323 are consistent in size, and each air gap 323a of each transformer core column 323 is identical. In some implementations, each air gap 323a of each transformer core column 323 is smaller than each air gap 313a of each inductor core column 313. In some implementations, the inductor central core column 315, each inductor core column 313, the transformer central core column 325 and each transformer core column 323 are not coupled to each other. In some implementations, each primary side winding coil 324a and each secondary side winding coil 324b disposed on each transformer core column 323 are wound clockwise, and each winding coil 314 disposed on each inductor core column 313 is wound clockwise. In some implementations, each primary side winding coil 324a and each secondary side winding coil 324b disposed on each transformer core column 323 are wound counterclockwise, and each winding coil 314 disposed on each inductor core column 313 is wound counterclockwise.

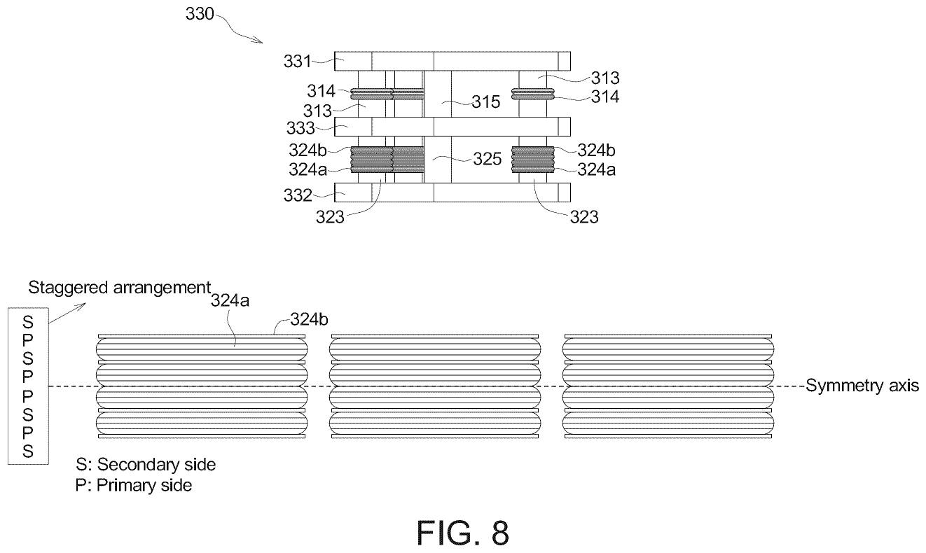

FIG. 8 is illustrating a side view of the integrated inductor and transformer structure 330 and an arrangement diagram of the transformer winding coil (each primary side winding coil 324a and each secondary side winding coil 324b) of the multi-phase converter, according to some implementations of the present disclosure. As shown in FIG. 8, the primary side winding coil 324a and the secondary side winding coil 324b on each transformer core column 323 are respectively arranged staggered on both sides of the symmetry axis (on the symmetry axis, two primary side winding coils 324a are adjacent, without any secondary side winding coil 324b disposed therebetween). Since the circuit of the three phases converter structure in this example is prone to uneven currents in each phase caused by inconsistent sizes of stray components on the circuit, the above “symmetrical winding method” is used, to make the loss caused by AC resistance smaller, wherein the primary side winding coil 324a and the secondary side winding coil 324b are arranged in a staggered manner. In some implementations, the location of the air gap (he air gap 313a of the inductor core column 313 or the air gap 323a of the transformer core column 323) are in the middle of each inductor core column 313 and each transformer core column 323. For reducing the influence of the air gap, Litz Wire coils can be used in coils around the air gap (the winding coil 314 on each inductor core column 313, or the primary side winding coil 324a or the secondary side winding coil 324b on each transformer core column 323) to significantly reduce the AC loss caused by the air gap to the coil.

The switching elements (transistors or switches) described herein, such as PMOS and NMOS transistors of first transistors and second transistors, can be replaced with each other regarding the use of these transistors, and the types of transistors can be arbitrarily combined or changed to achieve equivalent functions. The transistor types and combinations are not limited to descriptions in the multiple embodiments of the present disclosure.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A multi-phase converting circuit, comprising:
a primary side switch circuit, including a plurality of transistor complementary pairs, wherein the plurality of transistor complementary pairs are parallel-connected;
a resonant tank, coupled to the primary side switch circuit and comprising a plurality of capacitors, a plurality of resonant inductors and a plurality of transformers; and
a secondary side switch circuit, constructed by a full bridge structure,
wherein each of the plurality of transistor complementary pairs comprises a first transistor and a second transistor, and the first transistor and the second transistor are serial-connected,
wherein each of the plurality of transistor complementary pairs comprises a node between the first transistor and the second transistor, and the node is coupled to respective one of the plurality of resonant inductors.

2. The multi-phase converting circuit of claim 1, wherein each of the plurality of resonant inductors of the resonant tank is serial-connected to one of the plurality of capacitors and one of the plurality of the transformers.

3. The multi-phase converting circuit of claim 1, wherein a first control terminal of the first transistor and a second control terminal of the second transistor of each of the plurality of transistor complementary pairs are coupled to a controller,
wherein the controller operates a 120 degrees phase difference between the first transistors of the plurality of transistor complementary pairs, a 120 degrees phase difference between the second transistors of the plurality of transistor complementary pairs, and a 180 degrees phase difference between the first transistor and the second transistor of each of the plurality of transistor complementary pairs.

4. The multi-phase converting circuit of claim 3, wherein when the primary side switch circuit is coupled to an input power, a 120 degrees phase difference is between a plurality of inductor currents of each node of the plurality of transistor complementary pairs,
wherein each of the plurality of inductor currents flows from each node to the respective one of the plurality of resonant inductors coupled to the node.

5. The multi-phase converting circuit of claim 3, wherein, according to a parasite capacitance of the primary side switch circuit and the secondary side switch circuit, and a magnetizing inductor of the plurality of transformers, the controller sets a dead zone time between switching timings of the first transistor and the second transistor of a respective one of the plurality of transistor complementary pairs, to prevent the first transistor and the second transistor of the respective one of the complementary pairs of transistors from being turned on simultaneously,
wherein, when the magnetizing inductor is less than a threshold, the dead zone time is set as a first time duration,
wherein, when the magnetizing inductor is greater than a threshold, the dead zone time is set as a second time duration, wherein the first time duration is less than the second time duration.

6. A multi-phase converter, comprising:
a plurality of resonant inductor structures, each of the plurality of resonant inductor structures comprising an inductor upper cover, an inductor lower cover, an inductor core column and a winding coil, wherein the inductor core column is disposed between the inductor upper cover and the inductor lower cover, and includes an air gap, wherein the winding coil is arranged around the inductor core column;
a plurality of transformer structures, each of the plurality of transformer structures comprising a transformer upper cover, a transformer lower cover, a transformer core column, a primary side winding coil and a secondary side winding coil, wherein the transformer core column is disposed between the transformer upper cover and the transformer lower cover, and includes an air gap, wherein the primary side winding coil and the secondary winding coil are arranged around the transformer core column;
a primary side switch circuit, including a plurality of transistor complementary pairs, wherein the plurality of transistor complementary pairs are parallel-connected; and
a secondary side switch circuit, coupled to each secondary side winding coil of the plurality of transformer structures and constructed by a full bridge structure,
wherein each of the plurality of transistor complementary pairs comprises a first transistor and a second transistor, and the first transistor and the second transistor are serial-connected,
wherein each of the plurality of transistor complementary pairs comprises a node between the first transistor and the second transistor, and the node is coupled to the winding coil of respective one of the plurality of resonant inductor structures,
wherein the primary side winding coil of one of the plurality of transformer structures is coupled to the winding coil of one of the plurality of resonant inductor structures.

7. The multi-phase converter of claim 6, wherein each inductor upper cover of the plurality of resonant inductor structures form an integrated upper cover, and each inductor lower cover of the plurality of resonant inductor structures, and each transformer upper cover of the plurality of transformer structures form an integrated middle layer, wherein an inductor central core column is disposed between the integrated upper cover and the integrated middle layer and on the geometric center of the integrated upper cover and the integrated middle layer,
wherein the inductor central core column is without an air gap, and the inductor central core column and each inductor core column are equidistant from each other,
wherein each transformer lower cover of the plurality of transformer structures form an integrated lower cover, and an transformer central core column is disposed between the integrated middle layer and the integrated lower cover and on the geometric center of the integrated middle layer and the integrated lower cover,
wherein the transformer central core column is without an air gap, and the transformer central core column and each transformer core column are equidistant from each other.

8. The multi-phase converter of claim 6, wherein a first control terminal of the first transistor and a second control terminal of the second transistor of each of the plurality of transistor complementary pairs are coupled to a controller,
wherein the controller operates a 120 degrees phase difference between the first transistors of the plurality of transistor complementary pairs, a 120 degrees phase difference between the second transistors of the plurality of transistor complementary pairs, and a 180 degrees phase difference between the first transistor and the second transistor of each of the plurality of transistor complementary pairs.

9. The multi-phase converter of claim 8, wherein when the primary side switch circuit is coupled to an input power, a 120 degrees phase difference is between a plurality of inductor currents of each node of the plurality of transistor complementary pairs,
wherein each of the plurality of inductor currents flows from each node to the respective one of the plurality of resonant inductors coupled to the node.

10. The multi-phase converter of claim 8, wherein, according to a parasite capacitance of the primary side switch circuit and the secondary side switch circuit, and a magnetizing inductor of the plurality of transformers, the controller sets a dead zone time between switching timings of the first transistor and the second transistor of a respective one of the plurality of transistor complementary pairs, to prevent the first transistor and the second transistor of the respective one of the complementary pairs of transistors from being turned on simultaneously,
wherein, when the magnetizing inductor is less than a threshold, the dead zone time is set as a first time duration,
wherein, when the magnetizing inductor is greater than a threshold, the dead zone time is set as a second time duration, wherein the first time duration is less than the second time duration.
